(19) United States
(12) Patent Application Publication
(10) Pub. No.: US 2015/0337787 A1
(43) Pub. Date: Nov. 26, 2015

(54) METHOD FOR DETERMINING THE AMOUNT OF FUEL INJECTED INTO AN ENGINE, IN PARTICULAR A DIESEL ENGINE

(71) Applicants: Continental Automotive France, Toulouse (FR); Continental Automotive GmbH, Hannover (DE)

(72) Inventors: Bertrand VAROQUIE, Eaunes (FR); Cyril JUVENELLE, Bad Abbach (DE)

(21) Appl. No.: 14/653,227

(22) PCT Filed: Dec. 17, 2013
(86) PCT No.: PCT/EP2013/003820

§ 371 Date: Jun. 17, 2015

(30) Foreign Application Priority Data
Dec. 18, 2012 (FR) 1262229

(51) Int. Cl. F02M 65/00; F02D 35/02; F02D 41/30

(52) U.S. Cl. CPC F02M 65/001; F02D 41/30; F02D 35/023; F02D 35/026

(57) ABSTRACT

A method for determining a mass of fuel injected into an internal combustion engine cylinder provided with a pressure sensor, includes: determining the temperature prevailing in the cylinder and amount heat released from the measured pressure; integrating amounts of heat released over a predetermined time interval to determine a cumulative amount of heat; estimating the heat losses by taking into account heat losses due to radiation and which are dependent on the measured temperature to the fourth power, and heat losses due to conduction and/or convection and dependent on both the measured temperature and corresponding engine speed, according to the formula: QP=α HR_{CUM}, where QP is the amount of heat corresponding to the heat losses, HR_{CUM} is the cumulative amount of heat, a is a corrective factor; and determining the amount of fuel injected, which is proportional to the cumulative amount of heat added to the heat losses.

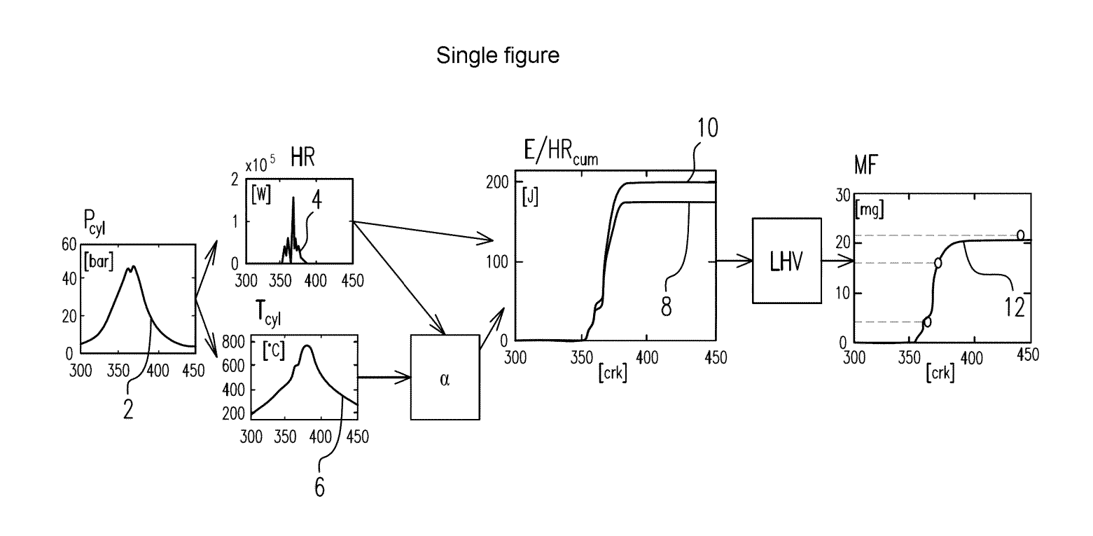

The present invention concerns a method for determining the amount of fuel injected into an engine, in particular a diesel type engine.

In a diesel type engine, air is compressed in a combustion chamber then fuel is injected under pressure into this chamber. The temperature and pressure conditions in the chamber during injection are such that the fuel is then burned.

For better management of the engine and to limit emissions, it is useful to control as far as possible the conditions under which the fuel is burned within the combustion chamber. With regard to the fuel injection, it is preferable not to inject the amount of fuel necessary for combustion in a single injection, but to carry out an initial injection called the “pilot injection” followed by a second injection or “main injection”. During the pilot injection, a small amount of fuel is injected in one injection or in several successive “microinjections”. Combustion of this fuel allows an increase in temperature and pressure within the combustion chamber, and thus promotes combustion of the fuel injected during the main injection. This method of injecting fuel firstly allows a reduction in engine noise, and secondly limits the emissions of nitrous oxides grouped under the compound name NO_{R}, for example nitrogen monoxide NO and nitrogen dioxide NO₂.

The present invention here is concerned in particular with controlling the amount of fuel injected into a combustion chamber during a cycle.

The fuel is injected into the combustion chamber by injectors which supply a quantity of fuel as a function of a signal received from the corresponding engine control and management means. These injectors have characteristics which drift with a sensitivity inherent in their initial design as a function of aging, operating conditions etc.

The amounts of fuel injected are managed by a function integrated in each injector in order to measure the quantities actually injected, which allows correction of the amounts injected if a discrepancy is found between the desired amount and the amount actually injected. This control function is generally developed by the injector manufacturer and is usually based on analysis of the oscillation of the engine speed during a test injection and/or on analysis of the richness if the engine is equipped with a lambda sensor.

Document FR 2 901 848 describes a method and a flow correction device for a pilot injection. The device described comprises a module for estimating flow values based either on pressure measurement within the cylinders, from which heat release values are derived, or on measurement of the engine revolutions, from which differences in rotation speed are derived, with or without pilot injection.

The prior art teaches consideration of heat losses according to a model developed by G. Woschni, which consists of calculating losses for all crankshaft angles. Such a method of considering heat losses requires a memory space and calculation time which are incompatible with the speed of performance of successive engine cycles of an internal combustion engine, the size and the cost of engine computers.

Documents DE 10 2007 061225 A1 and FR 2 846 373 A1 teach methods for determining a mass of fuel injected into a cylinder of an internal combustion engine from the cylinder pressure and calculation of the quantity of heat released. These models do not take account of heat losses.

In relation to the solutions known from the prior art, the object of the present invention is to provide a more precise method for determining the amount of fuel injected by an injector.

The solution proposed by the invention is preferably independent of the transmission coupled to the engine. In this way, it is possible to reduce costs in the management of vehicle platforms sharing common engines.

To this end, the present invention proposes a method for determining a mass of fuel injected into a cylinder of an internal combustion engine, said cylinder being equipped with a sensor able to detect the pressure predominating in the interior thereof.

According to the present invention, this method comprises the following steps:
determining, from the pressure measured, firstly the corresponding temperature prevailing in the cylinder and secondly the quantity of heat released,
integrating the quantities of heat released over a predefined time interval in order to determine a cumulative quantity of heat,
estimating heat losses by taking into account firstly the heat losses by radiation which are dependent on the measured temperature to the power of four, and secondly the heat losses by conduction and/or convection which are dependent both on the measured temperature and on the corresponding engine speed, according to the formula:

Q_{P}=α HR_{CUM}

where:
Q_{P} is the quantity of heat corresponding to the heat losses,
HR_{CUM} is said cumulative heat quantity,
α is a corrective factor for the cumulative heat quantity,
determining the amount of fuel injected which is proportional to the cumulative quantity of heat plus the heat losses.

In an original fashion, this method makes an estimation using a model based on the total energy released by combustion of the fuel in the combustion chamber. It allows very precise results thanks to consideration of the heat losses, which becomes possible with the model as defined in the invention. According to this model, the heat losses are taken into account following a particularly advantageous choice in the context of the engine control system. In particular, the choice according to the invention of the formulation of heat losses proportional to the heat release calculated over the entire engine cycle concerned allows the corrective factor for the cumulative heat quantity to be considered constant during the combustion cycle of said engine cycle. This corrective factor is therefore independent of the angular position of the crankshaft in the cycle concerned. Consequently, in particular, the memory space and calculation time for a computer using such a method are limited.

In this determination method according to the invention, the temperature may be calculated from the pressure by assuming that the ratio of the product of pressure and volume firstly and temperature secondly is constant.

The quantities of heat released are integrated for example over a complete combustion cycle, i.e. over an interval of 720° for a four-stroke engine. However, calculations may be carried out over a shorter interval in order for example to monitor the pilot injections performed during the fuel injection. It is also possible to monitor development of the mass injected during the combustion cycle relative to and as a function of the rotation angle of the crankshaft.

To improve the accuracy of the determination method according to the invention, the estimation of heat losses advantageously also takes into account the increase in the density of the gaseous flow before it enters the cylinder.

To implement the method for determining the mass of fuel injected into the combustion chamber, a preferred variant embodiment is proposed here which provides that the heat losses by radiation are estimated using the formula:

Q_{R}=B HR_{CUM}(Tₘₐₓ⁴−T_{CO}⁴)/T_{CO}⁴

where:
Q_{R} is the quantity of heat dissipated by radiation,
B is a constant,
HR_{CUM} is the cumulative heat quantity,
Tₘₐₓ is the maximum temperature determined over the predefined time interval taken into account for determining the cumulative heat quantity,
T_{CO} is the engine temperature.

Similarly, a preferred variant embodiment provides that the heat losses by conduction and/or convection are estimated using the formula:

Q_{C}=f(N) HR_{CUM}(Tₘₐₓ−T_{CO})/T_{CO}

where:
Q_{C} is the quantity of heat dissipated by conduction and/or convection,
f(N) is a function with variable N corresponding to the engine speed,
Tₘₐₓ is the maximum temperature determined over the predefined time interval taken into account for determining the cumulative heat quantity,
T_{CO} is the engine temperature.

By using the preferred variants above, it is proposed that the heat losses are estimated using the formula:

Q_{P}=A HR_{CUM}+Q_{R}+Q_{C}+C HR_{CUM} Pᵢₙ/P_{amb}

where:
Q_{P} is the quantity of heat corresponding to the heat losses,

A and C are constants,
Pᵢₙ is the pressure of a gaseous flow immediately before it enters the cylinder,
P_{amb} is the ambient pressure,
   in which formula, said corrective factor a for the cumulative heat quantity is entered as follows:

α=A+B (Tₘₐₓ⁴−T_{CO}⁴)/T_{CO}⁴+f(N) (Tₘₐₓ−T_{CO})/T_{CO}+C Pᵢₙ/P_{amb}.

The present invention also concerns a method for correcting the flow of fuel injected into an internal combustion engine, characterized in that it comprises the following steps:
determination of the amount of fuel injected during a combustion cycle as described above,
comparison of the amount of fuel determined in the previous step with a reference value corresponding to the amount of fuel to be injected during the same combustion cycle, and
repetition of the previous steps of determination and comparison,
use of the results of comparisons between the amount of fuel determined by a method as described above and reference amounts, in order to define a correction value to apply to a reference value corresponding to an amount of fuel to be injected.

The present invention also concerns a device for determining an amount of fuel injected into a cylinder of an internal combustion engine, characterized in that it comprises means for implementing each of the steps of a method as described above.

The present invention also concerns a device for management and control of an internal combustion engine, characterized in that it comprises means for implementing each of the steps of a method as described above.

Details and advantages of the present invention will appear more clearly from the description which follows, with reference to the attached diagrammatic drawings in which:

The only figure shows diagrammatically the steps of a method for determining an amount of fuel injected into a cylinder of an internal combustion engine according to the present invention.

The method illustrated on the single attached figure allows determination of the cumulative mass of fuel injected into a cylinder of an internal combustion engine. The present invention more particularly concerns compression ignition engines, also known as diesel engines. In such an engine, the cylinders are arranged in an engine block and closed by a cylinder head. A piston is movable in each cylinder and defines a combustion chamber of variable volume with cylinder head and walls of the corresponding cylinder. The pistons, which execute a translation movement in their cylinders, are connected to a crankshaft driven in a rotational movement. We shall now consider such an engine functioning on a four-stroke cycle, as is well known to the person skilled in the art. Thus to perform a complete cycle in a cylinder, the crankshaft performs two revolutions, through 720°.

To implement the present invention, at least one of the cylinders is equipped with a pressure sensor which measures the pressure in the corresponding pressure chamber.

The present invention proposes to estimate the mass of fuel injected into a cylinder equipped with a pressure sensor during a complete combustion cycle, using a model based on the total energy released by combustion of this fuel. This total energy is calculated in particular from information provided by the pressure sensor of the corresponding cylinder.

On the only figure, a first curve 2 illustrates the measured pressure P_{cyl} measured as a function of the angular position of the crankshaft. Here we consider for example an interval from 0° to 720° of crankshaft rotation. The curve 2 is shown only on a part of this interval which corresponds to the part of the curve where the pressure variations are at their greatest.

To determine the amount of fuel injected during the combustion cycle concerned, the total energy released by combustion of the fuel injected must be calculated. This total energy E is the sum firstly of a heat release HR which is transformed into work, and secondly of the heat losses Q in the cylinder.

E=HR+Q

The heat release HR at a given point corresponding to the position θ of the crankshaft is given by the following relationship:

$$H R ( θ ) = \frac{g}{g - 1} \times {P}_{cyl} \times \frac{d V}{d θ} + \frac{1}{g - 1} \times V \times \frac{d {P}_{cyl}}{d θ}$$

where:
g is the constant of perfect gases, which is for example here set at 1.32 in order to obtain a representative value of the gases in the expansion phase of the combustion cycle,
dV/dθ is the differential of the volume of the combustion chamber relative to the rotation angle of the crankshaft,
N is the rotation speed of the crankshaft,
V is the volume of the combustion chamber (depends both on θ and on P_{cyl}),
dP_{cyl}/dθ is the differential of the pressure prevailing in the combustion chamber relative to the rotation angle of the crankshaft.

The heat release HR as a function of time is given by the following formula:

HR(t)=HR(θ)×6×N.

On the single figure, a graph 4 shows the course normally taken by the heat release HR as a function of the angular position of the crankshaft.

HR_{CUM} is the total or cumulative quantity of heat released at the combustion chamber, naturally excluding the heat losses since this heat quantity results from the cylinder pressure. We then have:

HR_{CUM}^{θ}^{₁₈₀}^{^{?}}^{HR(θ)×6×N}

It is proposed that the heat losses Q be expressed in the following form:

QP=αHR_{CUM}

We then have:

E=(1+α) HR_{CUM}

with α>0.

The term α can be considered as a corrective term, or in other words the heat losses are a corrective factor for the heat release occurring at a cylinder.

The present invention considers that the heat losses are primarily due to thermal radiation linked to the high temperatures in the cylinder, and to convection and/or conduction of heat at the walls of the combustion chamber. Q_{R} is the heat loss linked to radiation, and Q_{C} the heat loss linked to conduction and/or convection during a combustion cycle.

The present invention proposes to formulate Q_{R} as follows:

Q_{R}=B HR_{CUM}(Tₘₐₓ⁴−T_{CO}⁴)/T_{CO}⁴

where:
B is a constant to be determined by calibration,
Tₘₐₓ is the maximum temperature determined over the combustion cycle,
T_{CO} is the engine temperature. A sensor is provided in all modern engines to monitor this engine temperature which corresponds to the coolant temperature.

The temperature in the combustion chamber may be determined from the pressure measurement. In fact for a given quantity of gas, the quotient PV/T is constant, P representing the gas pressure, V its volume and T its temperature. By taking as a reference the volume of gas (air) which is introduced into the combustion chamber, we have the following equation:

PᵢₙVᵢₙ/Tᵢₙ=P_{cyl}(θ)V(θ)/T_{cyl}(θ)

where:
Pᵢₙ is the air pressure on entry to the combustion chamber,
Vᵢₙ corresponds to the maximum volume of the combustion chamber,
Tᵢₙ corresponds to the temperature of the air entering the combustion chamber.

We therefore obtain:

T_{cyl}(θ)=P_{cyl}(θ)V(θ)Tᵢₙ/Pᵢₙ Vᵢₙ

This relationship thus gives the corresponding temperature for each pressure measurement in the cylinder, since the variation in volume relative to the crankshaft position is known. A curve 6 on the single figure illustrates the temperature profile as a function of the crankshaft angular position.

In the same way as for the losses by radiation, the invention proposes formulating Q_{C} as follows:

Q_{C}=f(N) HR_{CUM} (Tₘₐₓ−T_{CO})/T_{CO}

where f(N) is a function with variable N corresponding to the engine speed. This function is determined by calibration. It is usually a decreasing function.

To obtain a more precise assessment of the heat losses, it is preferable also to take into account the increase in air density relative to ambient air. It is then proposed that a corrective term also be introduced to take into account this density increase. Therefore the quotient Pᵢₙ/P_{amb} should be introduced into the formulation giving the corrective term α, where Pᵢₙ is the air pressure before it enters the cylinder as defined above and P_{amb} is the ambient pressure.

Globally, in view of the description above, in a preferred embodiment of the present invention, we then have:

α=A+B (Tₘₐₓ⁴−T_{CO}⁴)/T_{CO}⁴+f(N) (Tₘₐₓ−T_{CO})/T_{CO}+C Pᵢₙ/P_{amb}

where A is a constant and the other terms have already been defined.

In this formula, the constants A, B and C are obtained by calibration as is the function f(N).

As indicated above, the total or cumulative heat quantity HR_{CUM} which corresponds to useful work performed by the engine is obtained by integration. The heat losses correspond to αHR_{CUM}, and the total energy E supplied by the fuel introduced into the combustion chamber is the sum of the useful work and the losses. A curve 8 is depicted diagrammatically on the single figure to illustrate the integral of the heat quantity, and a curve 10 illustrates the integral of total energy relative to the crankshaft rotation angle (crk).

The mass of fuel burned is directly proportional to the total energy released during the combustion cycle. If LHV (lower heating value) is the coefficient indicating the quantity of heat released during combustion per unit of mass of fuel, we have:

MF=E/LHV

where MF is the mass of fuel desired.

On the single figure, a curve 12 shows the development of MF during a combustion cycle.

The person skilled in the art will understand that the method described above may be performed either to establish the amount of fuel injected over a complete combustion cycle, or to determine the development of the amount of fuel injected during a combustion cycle. In the first case, a single calculation may be performed at the end of the combustion cycle. In the second case, a calculation may be performed for example at each degree of rotation of the crankshaft. In the latter case, it is possible to manage the pilot injections of the injections into the cylinder, but numerous calculations are required and consequently a computer must be provided which is able to perform all these calculations.

In all cases, the method according to the present invention gives knowledge of the total amount of fuel injected into a cylinder equipped with a pressure sensor. This knowledge allows diagnosis of a corresponding fuel injector drift if a difference is constantly established between the total amount of fuel injected, as measured by the method described above, and the amount of fuel to be injected (reference value).

A method for correcting the flow of fuel injection into an internal combustion engine then comprises the following steps:
determination of the amount of fuel injected during a combustion cycle as described above,
comparison of the amount of fuel determined in the previous step with a reference value corresponding to the amount of fuel to be injected during the same combustion cycle, and
repetition of the previous steps of determination and comparison,
use of the results of comparisons between the amounts of fuel determined by a method as described above and the reference amounts, in order to define a correction value to apply to a reference value corresponding to an amount of fuel to be injected.

Tests performed have shown that determination of the amount of fuel injected with the method according to the invention is precise and robust. It may be used under all conditions of operation of the engine, on start-up, at constant speed, with a cold or warm engine, at all rotation speeds and all engine loadings.

The present invention is not limited to the preferred embodiment described above as a non-limitative example, but also concerns all variant embodiments mentioned and those within the scope of the person skilled in the art.

1. A method for determining a mass of fuel injected into a cylinder of an internal combustion engine, said cylinder being equipped with a sensor able to detect the pressure predominating in the interior thereof, the method comprising the following steps:
determining, from the pressure measured, firstly the corresponding temperature prevailing in the cylinder and secondly the quantity of heat released,
integrating the quantities of heat released over a predefined time interval in order to determine a cumulative quantity of heat,
estimating heat losses by taking into account firstly the heat losses by radiation which are dependent on the measured temperature to the power of four, and secondly the heat losses by conduction and/or convection which are dependent both on the measured temperature and on the corresponding engine speed, according to the formula:
Q_{P}=α HR_{CUM}
where:
Q_{P} is the quantity of heat corresponding to the heat losses,
HR_{CUM} is said cumulative heat quantity,
α is a corrective factor for the cumulative heat quantity,
determining the amount of fuel injected which is proportional to the cumulative quantity of heat plus the heat losses.

2. The determination method as claimed in claim 1, wherein the temperature is calculated from the pressure by assuming that the ratio of the product of pressure and volume firstly and temperature secondly is constant.

3. The determination method as claimed in claim 1, wherein the quantities of heat released are integrated over a complete combustion cycle, i.e. over an interval of 720° for a four-stroke engine.

4. The determination method as claimed in claim 1, wherein the estimation of heat losses also takes into account the increase in the density of the gaseous flow before it enters the cylinder.

5. The determination method as claimed in claim 1, wherein the heat losses by radiation are estimated using the formula:
Q_{R}=B HR_{CUM} (Tₘₐₓ⁴−T_{CO}⁴)/T_{CO}⁴
where:
Q_{R} is the quantity of heat dissipated by radiation,
B is a constant,
HR_{CUM} is the cumulative heat quantity,
Tₘₐₓ is the maximum temperature determined over the predefined time interval taken into account for determining the cumulative heat quantity,
T_{CO} is the engine temperature.

6. The determination method as claimed in claim 1, wherein the heat losses by conduction and/or convection are estimated using the formula:
Q_{C}=f(N) HR_{CUM} (Tₘₐₓ−T_{CO})/T_{CO}
where:
Q_{C} is the quantity of heat dissipated by conduction and/or convection,
f(N) is a function with variable N corresponding to the engine speed,
Tₘₐₓ is the maximum temperature determined over the predefined time interval taken into account for determining the cumulative heat quantity,
T_{CO} is the engine temperature.

7. The determination method as claimed in claim 4, wherein the heat losses are estimated using the formula:
Q_{P}=A HR_{CUM}+Q_{R}+Q_{C}+C HR_{CUM} Pᵢₙ/P_{amb}
where:
Q_{P} is the quantity of heat corresponding to the heat losses,
A and C are constants,
Pᵢₙ is the pressure of a gaseous flow immediately before it enters the cylinder,
P_{amb} is the ambient pressure,
in which formula, said corrective factor a for the cumulative heat quantity is entered as follows:
α=A+B (Tₘₐₓ⁴−T_{CO}⁴)/T_{CO}⁴+f(N) (Tₘₐₓ−T_{CO})T_{CO}+C Pᵢₙ/P_{amb}.

8. A method for correcting the flow of fuel injected into an internal combustion engine, which comprises the following steps:
determination of the amount of fuel injected during a combustion cycle as claimed in claim 1,
comparison of the amount of fuel determined in the previous step with a reference value corresponding to the amount of fuel to be injected during the same combustion cycle, and
repetition of the previous steps of determination and comparison,
use of the results of comparisons between the amounts of fuel determined by the method and reference amounts, in order to define a correction value to apply to a reference value corresponding to an amount of fuel to be injected.

9. A device for determining an amount of fuel injected into a cylinder of an internal combustion engine, said cylinder being equipped with a sensor giving knowledge of the pressure prevailing therein, the device comprising a computer containing means for implementing each of the steps of a method as claimed in claim 1.

10. The determination method as claimed in claim 2, wherein the quantities of heat released are integrated over a complete combustion cycle, i.e. over an interval of 720° for a four-stroke engine.

11. The determination method as claimed in claim 2, wherein the estimation of heat losses also takes into account the increase in the density of the gaseous flow before it enters the cylinder.

12. The determination method as claimed in claim 3, wherein the estimation of heat losses also takes into account the increase in the density of the gaseous flow before it enters the cylinder.

13. The determination method as claimed in claim 5, wherein the heat losses are estimated using the formula:
Q_{P}=A HR_{CUM}+Q_{R}+Q_{C}+C HR_{CUM} Pᵢₙ/P_{amb}
where:
Q_{P} is the quantity of heat corresponding to the heat losses,
A and C are constants,
Pᵢₙ is the pressure of a gaseous flow immediately before it enters the cylinder,
P_{amb} is the ambient pressure,
in which formula, said corrective factor a for the cumulative heat quantity is entered as follows:
α=A+B (Tₘₐₓ⁴−T_{CO}⁴)/T_{CO}⁴+f(N) (Tₘₐₓ−T_{CO})/T_{CO}+C Pᵢₙ/P_{amb}.

14. The determination method as claimed in claim 6, wherein the heat losses are estimated using the formula:
Q_{P}=A HR_{CUM}+Q_{R}Q_{C}+C HR_{CUM} Pᵢₙ/P_{amb}
where:
Q_{P} is the quantity of heat corresponding to the heat losses,
A and C are constants,
Pᵢₙ is the pressure of a gaseous flow immediately before it enters the cylinder,
P_{amb} is the ambient pressure,
in which formula, said corrective factor a for the cumulative heat quantity is entered as follows:
α=A+B (Tₘₐₓ⁴−T_{CO}⁴)/T_{CO}⁴+f(N) (Tₘₐₓ−T_{CO})/T_{CO}+C Pᵢₙ/P_{amb}.
